(19) United States
(12) Patent Application Publication
(10) Pub. No.: US 2007/0043687 A1
(43) Pub. Date: Feb. 22, 2007

(54) Virtual assistant

(75) Inventors: Andrew J. Bodart, New York, NY (US); Chris Ernest Condon, Jesery City, NJ (US)

Correspondence Address: BANNER & WITCOFF, LTD.;ATTORNEYS FOR CLIENT NO. 005222, 10 S. WACKER DRIVE, 30TH FLOOR, CHICAGO, IL, 60606, US

(73) Assignee: Accenture LLP, Palo Alto, CA (US)

(21) Appl. No.: 11/206,829

(22) Filed: Aug. 19, 2005

(51) Int. Cl. G06F 17/30

(52) U.S. Cl. 707/1

(57) ABSTRACT

Systems and methods for assisting a user with a variety of tasks are provided. A virtual assistant has access to a user's contacts, calendar, and location. The virtual assistant also is able to access information about weather, traffic, and mass transit, and is able to adjust the time of for alerting a user about an upcoming appointment. The virtual assistant also has a rules engine enabling a user to create rules for handling incoming calls and instant messages, rerouting calls based on their caller identification. The virtual assistant also has a query engine enabling a user to find a document and to work with it, including sending it to a contact in the user's address book. Interfaces to virtual assistant may include installed software client, web browser, SMS/instant message, as well as an interactive voice response system.

### FIELD OF THE INVENTION

The invention relates generally to personal productivity systems. More particularly, the invention provides for the integration of personal and public information to enable more productive individuals by automating routine tasks.

### BACKGROUND

Personal productivity software has helped to streamline and simplify the role of information workers. Beginning with basic email clients, productivity software has grown to include a variety of other “desktop” applications, replacing paper calendars, rolodexes, and task lists with their software equivalents. Hybrid programs sometimes referred to as personal information managers (PIMs) have succeeded somewhat in combining these disparate programs into a single interface. Not only are such applications able to track appointments, to do's, contacts, and so forth, but they can combine the functions, such that setting up a meeting merely requires adding an appointment to your calendar and adding contacts to the appointment. Some applications have taken personal information managers a step further, enabling new interface methods, such as having a user's email read to her by phone.

Having all this relevant information available in one place may have enhanced user productivity, but these PIMs have failed to take full advantage of the information. For example, when a user creates a new appointment, she must still discern how long of a lead time will be needed for a reminder, or provide one default value that is used for all reminders. Furthermore, if the user is not at her desk when the reminder is triggered, then she may forget the appointment, and the reminder is wasted. Alternatively, when multiple devices are synchronized, duplicative reminders may be unnecessarily sent, e.g., to a user's computer PIM (e.g., Outlook® brand PIM), to a user's PDA PIM (e.g., GoodLink® brand PIM), and to a user's watch PIM (e.g., Microsoft Smart Watch). When a user receives an incoming message, she must decide whether to take the call or respond to the instant message based on whether she recognizes the identifying phone number or screen name. Such little decisions and annoyances can be time consuming. Ultimately, PIMs and their users do not take full advantage of the information available to them to further enhance productivity.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the more detailed description below.

A first illustrative embodiment may be directed to a system having an information sources software module for receiving data from a plurality of information providers. The system may also include a user interfaces software module for receiving input from and providing output to a plurality of heterogeneous user devices. A user data module may store data about a specific user, where the data about the specific user includes calendar appointment information, contact information, rules information, and preferences information. A functionality module may control overall operation of the system, and may include submodules such as a rules engine for analyzing and executing rules based on the rules information, and a real-time communication component. The real-time communication component may direct an incoming communication to the user. The routing may be determined at least in part based on a recognized contact status as determined by a comparison of a call identifier with the contact information, and optionally at least in part based on information received from one or more of the plurality of information providers via the information sources software module. The recognized contact status may recognize the caller as a human caller or an automated caller, such as a PIM associated with the user.

### OVERVIEW OF THE FIGURES

A more complete understanding of the present invention and the advantages thereof may be acquired by referring to the following description in consideration of the accompanying drawings, in which like reference numbers indicate like features, and wherein:

FIGS. 1 and 2 depict components of a virtual assistant according to one or more illustrative aspects of the invention;

FIG. 3 depicts a virtual assistant controlled alarm according to one or more illustrative aspects of the invention;

FIG. 4 is a flow chart illustrating a method for adjusting an alarm according to one or more illustrative aspects of the invention;

FIG. 5 depicts communication routing using a virtual assistant according to one or more illustrative aspects of the invention;

FIG. 6 is a flow chart illustrating a method for routing an incoming communication according to one or more illustrative aspects of the invention;

FIG. 7 depicts forwarding a file using a virtual assistant according to one or more illustrative aspects of the invention;

FIG. 8 is a flow chart illustrating a method for finding and forwarding a file according to one or more illustrative aspects of the invention;

FIG. 9 depicts controlling a virtual assistant using a remote controlled television according to one or more illustrative aspects of the invention;

FIG. 10 depicts sending data to an automobile using a virtual assistant according to one or more illustrative aspects of the invention;

FIG. 11 depicts controlling functions within a house according to one or more illustrative aspects of the invention; and

FIG. 12 is an illustrative operating environment in which one or more illustrative aspects of the invention may be implemented.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope and spirit of the present invention.

Throughout this description, various components and functional blocks are described as being connected to or in communication with each other. It should be understood that these components and functional blocks may be either directly or indirectly connected and may be in communication through any one of many methods, including wireless and/or wired technologies.

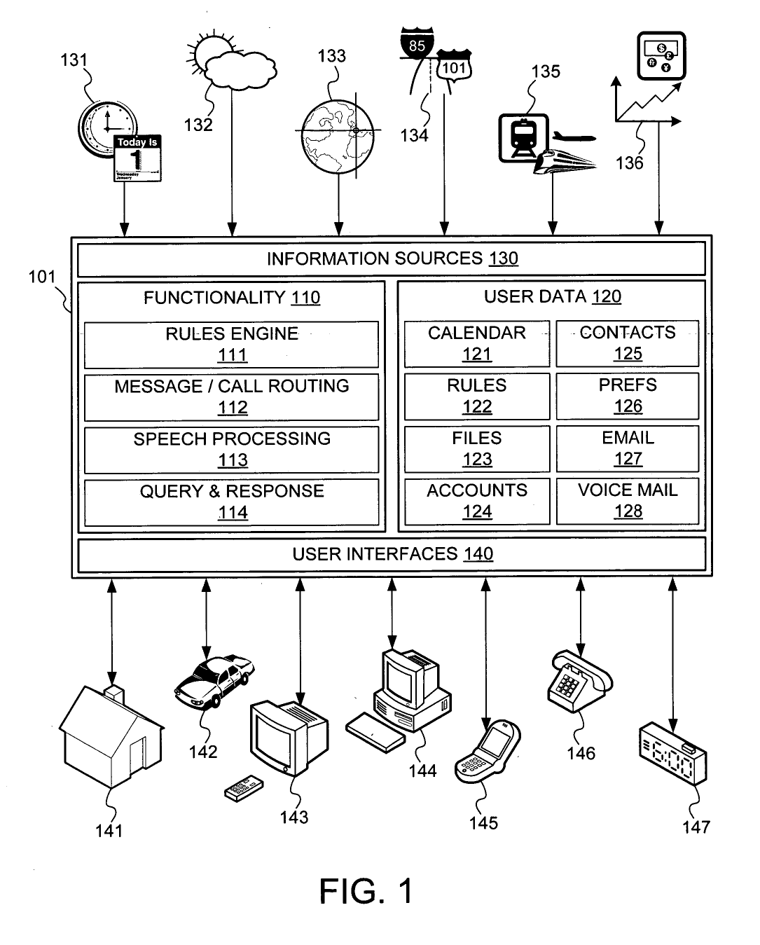

FIG. 1 depicts one possible set of components of a virtual assistant 101 according to one or more aspects of the invention. The term virtual assistant 101 is used to describe software designed to simplify, streamline and enhance the often repetitive activities which occupy the daily lives of many people. Such software may interact with a user via any number of interfaces 140. Furthermore, such software is able to retrieve data from a variety of information sources 130, in part to augment its ability to make decisions on the user's behalf. Virtual assistant 101 software further may include the ability to access user data 120, combined with technical functionality 110, to assist the user and make the most accurate decisions possible. The functionality depicted in FIG. 1 need not necessarily be part of a single device or system. Virtual assistant 101 functions may be performed by multiple devices in communication with each other.

User data 120 may be available to virtual assistant 101 either through its own user interface and data storage, or by electronic interface with the data and functions of other existing software packages. For example, user calendar 121 may be a component built into virtual assistant 101, or it may be a separate program (e.g., Microsoft Outlooks) which stores a user's calendar information and with which virtual assistant 120 can interface. Other user data may include contact information 125, the equivalent of a software rolodex, where users can store contact email addresses and phone numbers, along with other information. User data 120 may include a set of rules for use with rules engine 111, setting forth the logic used by virtual assistant to aid the user. In addition, there may be preference 126 data for individual application or operating system features. These preferences 126 may include preference settings for the virtual assistant software, or may include preferences for any other number of software programs or websites.

User data 120 may also include a collection of user files 123, possibly including documents, presentations, photographs, web pages, and so forth. These files may be designated by a user, or may include all the files on a local computer system. Furthermore, user data 120 may include the emails 127 that a user has received or sent. Accounts 124 may include personal financial account information for the user, possibly including bank login information. Accounts 124 may also include information for other types of user accounts, including email passwords, website passwords, and so forth. Finally, user data 120 may include any voice mail messages 128 left for or sent by a user.

As discussed, each of these types of user data 120 may be accessed and stored directly using specialized software components (e.g., interfaces and/or objects) which may be a part of virtual assistant 101. Alternatively, different user data 120 may be manipulated or created using software which is not a part of virtual assistant 101, and then be subsequently accessed by virtual assistant 101. Accessing data from other applications may require interfacing directly with another piece of software (e.g., through an application programming interface or API). It also may require accessing the data directly through files stored in a memory, whether volatile (e.g., dynamic random access memory or DRAM) or non-volatile (e.g., a hard drive). The types of user data 120 displayed in the figure is not exhaustive and other data may be made available to virtual assistant 101.

Rules engine 111 is one portion of the functionality found in virtual assistant 101. A rules engine may be compared with a software compiler which translates user input (i.e. computer source code) into a series of instructions which a computer processor can understand (i.e. computer object code). Rules engine 111 takes user-created rules, which may be represented as a series of textual if-then-else statements, and translates them into a series of actions. Like computer source code, the rules created for rules engine 111 may be portable and translatable on multiple computer platforms. Rules engine 111 may additionally infer new rules based on the rules already in place.

Message & call routing 112 is another portion of the functionality found in virtual assistant 101. Technologies such as voice over internet protocol (VoIP) may enable call routing functionality 112, where telephone conversations are converted to binary data which can be routed via a computer network such as the Internet. Message & call routing 112 may enable virtual assistant 101 to intercept incoming telephone calls, instant messages, and other real time communication requests. Based on the rules set forth for rules engine 111, calls may be selectively routed to a user based on the current context of date, time, user location, and so forth.

Speech processing 113 functionality can enable virtual assistant 101 to comprehend spoken language commands. Interactive voice response (IVR) technologies may enable speech processing 113 abilities for virtual assistant 101. Using this functionality, a remote user can call into his or her virtual assistant and provide voice commands. These can be interpreted into commands which control the functioning of virtual assistant 101.

Query and response 114 abilities may further enhance virtual assistant 101. Using a keyboard or speech processing, a user may query virtual assistant with regard to various aspects of user data 120 and/or information sources 130. For example, a user may request that virtual assistant find a particular contact, by typing or saying, “Find Contact John Doe.” Based on the result of a query, virtual assistant 101 may provide a response (e.g., whether the contact was found) as an audible or visual message. Similar queries may search user files 123, emails 127, calendar 121 appointments, and so forth. Additional functionality 110 may be implemented as a part of virtual assistant 101, including for example, the ability to initiate telephone calls and fax calls.

In addition to utilizing user data 120, virtual assistant 101 may receive information from various sources 130 using one or more computer networks. Each information source may provide different specialized data for use by query & response 114, rules engine 111, and other software components. These information sources 130 may reside on computer servers located within the same entity housing virtual assistant 101, or they may reside on remote networks, interconnected for example, via the Internet. Information may be pushed by the information sources 110 to virtual assistant 101, or it may be received in response to a request. The format used to send information may vary by information source, or sources may use a common format, such as extensible markup language (XML) or really simple syndication (RSS).

Among information sources 130, individual sources of information may include date & time information 131, weather information 132, user geographic location information 133, road traffic information 134, mass transit information 135, and finance information 136. Each of these information sources may supply timely information about their respective categories of data. Virtual assistant 101 receiving information from these sources 130 may utilize the information in combination with user data 120 and rules engine 111 to make decisions on behalf of a user. Examples of these types of decisions are set forth in some detail below. Other information sources may also or alternatively be used.

Other components of virtual assistant 101 include one or more user interfaces 140 which allow a user to interact with virtual assistant 101. These may include a home interface 141 (e.g., a home wired for digital control), an auto interface 142 (e.g., a navigation system), interactive television 143, computer 144, cell phone 145 and/or personal digital assistant (not shown), a conventional telephone 146, and even an alarm clock 147. Each interface may be directly associated with the equipment within which virtual assistant 101 is housed, or may be remotely located and in communication with virtual assistant 101 using a computer network or other electronic communication scheme. Via user interfaces 140, the virtual assistant 101 can communicate with many different types of heterogeneous user devices, and the virtual assistant is not limited to communication with a homogenous set of devices. Other interfaces may also or alternatively be used.

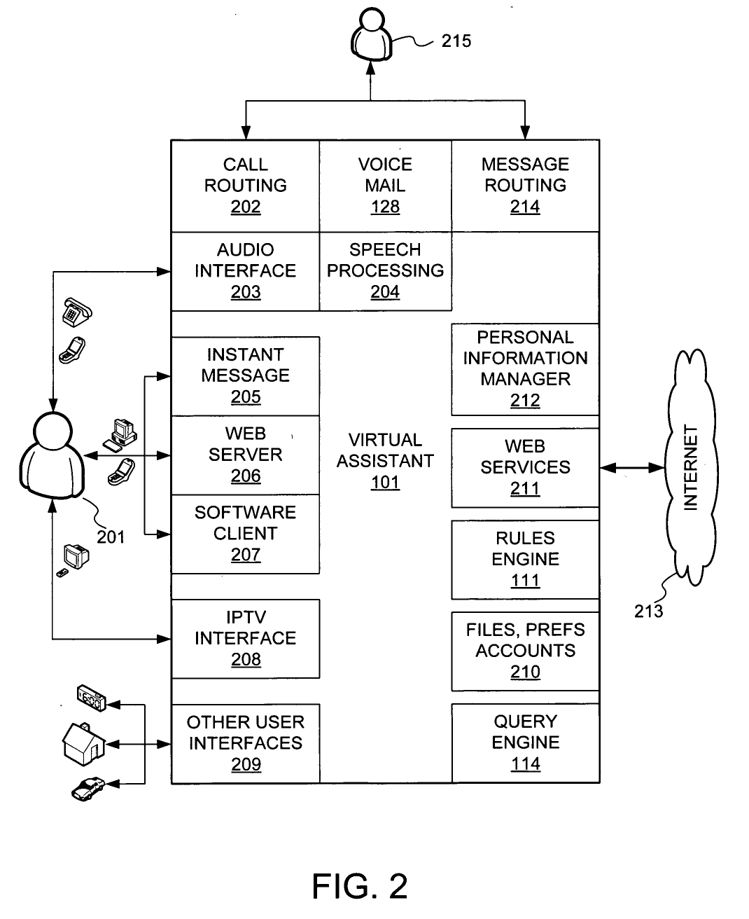

FIG. 2 depicts one possible component configuration of a virtual assistant 101 according to one or more aspects of the invention. The configuration may include the same or similar components as those shown in FIG. 1. The functional blocks present one possible implementation of virtual assistant 101. Components may be removed, rearranged, and other components may be added.

Here, virtual assistant 101 is comprised of a number of functional components which enable the overall functionality described. Each component may work in concert directly with the other components, or virtual assistant 101 may be developed using software so as to integrate the functions. For example, virtual assistant 101 may be primarily written in the computer language Java, and designed to interact with and integrate the various components, each of which may also share a public interface using Java, or some interface definition language (IDL).

User 201 may interact with virtual assistant 101 through one of many interfaces, as previously described. Interfaces may require some combination of visual, touch, or audible communications between user 201 and virtual assistant 101. For example, a user may control virtual assistant 101 using an audio interface 203 using a conventional telephone, a cell phone, or even a microphone and speaker attached to a computer. A user may use push button tones or another audio electronic interface to make selections from a menu. A user may also use natural language and/or spoken commands via audio interface 203. Speech processing 204 may then process spoken commands and translate them into text or another format which virtual assistant 101 can understand. Software components or systems which perform such speech processing may be referred to as interactive voice response (IVR) systems.

A visual interface may include those provided by instant messenger 205, web server 206, software client 207, or any other electronic interface. User 201 may interact using a computer, cell phone, or any other device which can receive and send commands. For instant message interface 205, a user may be able to send messages using an instant message client such as America Online (AOL) Instant Messenger, Microsoft Network (MSN) Messenger, and so forth. Alternatively, using a cell phone, user 201 may send messages using Short Message Service (SMS), multimedia message service (MMS) or some other message standard. Commands may be sent to virtual assistant 101 and responses received by the user using the same interface. Using the example of a virtual assistant 101 implemented using Java, SMS messages may be received and sent using a Java SMS Software Development Kit (SDK), or another set of software classes which ease the development process of SMS communications. Other programming languages may have similar SDK's to enable easy programming with SMS.

A web server 206 may supply an interface from virtual assistant 101 to any computer, cell phone, or other electronic device having a web browser via a computer network such as the Internet. Such an interface may provide pages formatted using Hypertext Markup Language (HTML) or some other markup language to provide information to user 201, and also to receive information from the user. The HTML pages may be created using a standard programming language such as Java Servlets or Java Server Pages (JSPs), Microsoft .NET, PHP, and so forth.

An installed software client 207 may provide a more rich and customizable interface for user 201. Such an interface may be an add-on to an existing piece of software (e.g., Microsoft Outlook), or a standalone computer application. Such an interface may be written using any number of programming languages, and may be installed on the same computer as virtual assistant 101 or communicate with the virtual assistant via a network connection.

Another alternative interface for virtual assistant 101 is an Internet Protocol Televeision (IPTV) interface 208. IPTV is not a particular standard and rather is a term used to refer generally to interactive services delivered to users over television broadband networks. IPTV may require that the user have a separate set top box connected to a television, although the functionality may be included as part of a television, or other video component. User 201 may receive information from virtual assistant 101 through her television. Likewise, user 201 may access and control virtual assistant 101 using a television remote or other input device.

Additional user interfaces 209 may interact with the devices mentioned, or with other devices and systems. For example, an interface may enable virtual assistant 101 to communicate with a home automation system 141 over an existing network connection. As another example, virtual assistant 101 may communicate using a wireless network with an automobile system 142 (e.g., a navigation system). Another example of a possible interface is virtual assistant 101 communicating with a user by controlling an alarm clock 147 connected to a home network. For each interface, an existing networking standard (e.g., HTML, XML, SMS, etc.) may be customized to enable communication with the appropriate device, and using the appropriate software calls.

Virtual assistant 101 includes a rules engine 111 as described above, capable of providing a user a simple way to automate the control of virtual assistant. One possible implementation of rules engine 111 is the use of the Java Jess application programming interface (API). Jess provides a generalized format for creating rules in a portable format, essentially a high-level declarative programming language. These rules can be run based on information from the various interfaces and information sources accessible by virtual assistant 101. The rules may be stored as user data and transported between multiple systems. Other types of rules engines may be used, each of which provides a way to make conclusions and inferences based on user data and contextual information.

A personal information manager (PIM) may form the basis of user data to be used by virtual assistant 101. Well-known PIMs include Microsoft Outlook, Microsoft Entourage, Lotus Notes, ACT, GoodLink, and so forth. Virtual assistant 101 may use the data associated with each of these well-known applications, or alternatively, virtual assistant may provide its own PIM functionality and store the data in a format of its choosing. The user data to which a PIM may provide access includes calendar appointments, address book contacts, to do list items, email messages, notes, and so forth. As opposed to one single application, each of these types of PIM data may alternatively be managed by individual applications (e.g., iCal, Address Book, and Mail on an Apple Computer). In either case, virtual assistant 101 may access each type of PIM data for use by user 201.

Web services 211 provide virtual assistant 101 a method of providing up-to-date contextual information for purposes of evaluating rules and responding to queries, among other uses. Web services may pull information from the Internet 213, including weather, traffic, mass transit, user location (e.g., via GPS in a user's cell phone), and so forth. This information may be provided using a simple request and response format, possibly polled on an hourly basis. Alternatively, the information may be requested on a “when needed” schedule, or the information may be pushed by outside servers when updated rather than awaiting a request. The data may be stored on a single server or on multiple servers throughout the Internet. In addition, virtual assistant 101 may pull the same information from multiple sources in order to average or otherwise determine the most correct information. Information may be pulled using XML or RSS, or some other standard or non-standard data format. Alternatively, information may be “scraped” from standard HTML web pages, where virtual assistant 101 may know exactly what part of a page contains the information needed.

Virtual assistant 101 may also access user files, preferences and account information 210 stored either locally on the same machine, or on remote servers and devices. Access may simply involve access to the item when a directory location or namespace is known, or it may include access to all the contents of all the items, possibly in the form of a complete index of item contents. Preferences may include application or operating system preferences, which may be transportable to other computers accessible to virtual assistant 101. Accounts may include passwords for specific websites, or possibly to bank accounts and the like. Information such as account balances (when authorized) may be useful in the types of decisions that virtual assistant 101 may make.

Virtual assistant 101 may include query engine 114, which may or may not work in conjunction with rules engine 111. Query engine 114 provides virtual assistant a method for finding files, items, data, and so forth within the realm of information available, including data gathered via web services 211. Query engine 114 may search an index structure for text matching a particular string or combination of strings. Query engine 114 may also perform natural language queries, which do not necessarily require a specific syntax or lexicon of commands. The responses provided by query engine may similarly be in the form of natural language rather than structured and limited. Speech processing 204 and audio interface 203 may work in conjunction with query engine 114 to provide a spoken input ability for queries. Furthermore, responses may be provided using audio interface 203 to produce a spoken output.

Virtual assistant 101 may include the ability to receive and direct calls and messages directed to user 201. Such ability includes call routing 202 where an incoming telephone call from contact 215 is routed based on the user's current status as well as whether or not the person making the call is recognized. Likewise, incoming messages including instant messages and/or SMS messages, and even email messages, may similarly be routed using message routing 214. By routing calls and messages, user 201 does not have to screen her calls. Rather, virtual assistant 101 is able to recognize an identity of the sender (via caller ID or some other identification method) and decide whether or not to route the call to voice mail 128 or some other system. Using speech processing 204, virtual assistant 101 may further translate a voice mail into a text message to be stored or forwarded to user 201.

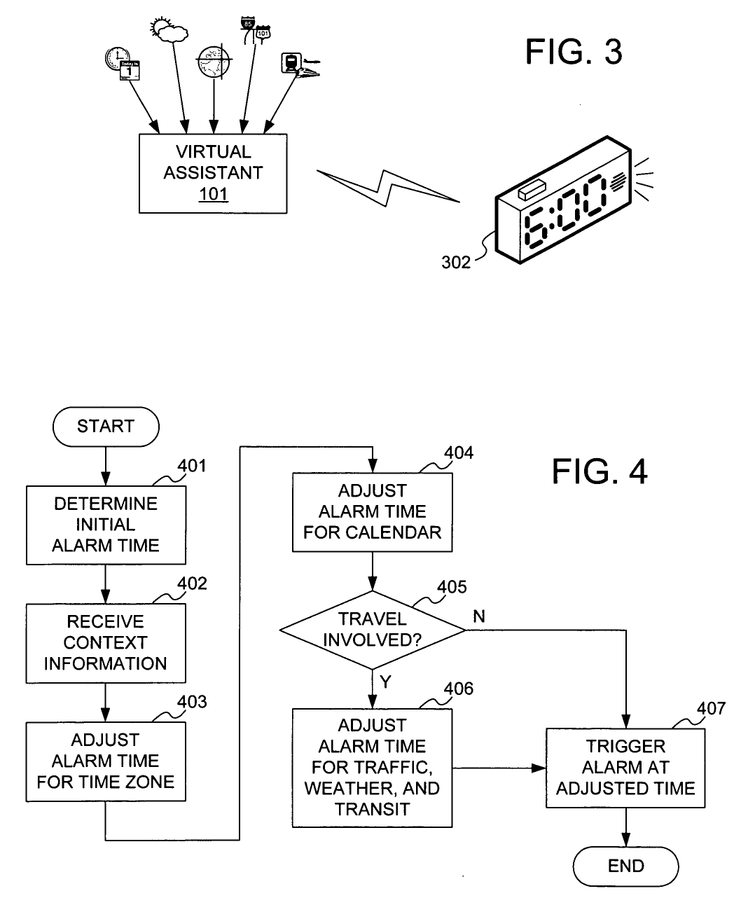

FIG. 3 depicts an alarm controlled by virtual assistant 101 according to one or more aspects of the invention. Although a conventional bedside alarm clock 302 is depicted here, any sort of audible, visual, or other alarm may be utilized in this fashion, including a computer alarm, a cell phone alarm, and so forth. Virtual assistant 101 may be incorporated into alarm 302, or it may be remotely located, utilizing a network or direct data connection in order to inform the alarm when to alert user 201. Virtual assistant 101 may have access to the location of user 302 via a cell phone or other location sensor. By knowing the user's location, virtual assistant 101 can automatically adjust the time zone and, if necessary, any calendar appointments for the user. Also, by having access to the calendar of user 201, virtual assistant can adjust an alarm (e.g., a wake-up alarm) based on any impending appointments.

If virtual assistant 101 not only knows the calendar of user 201, but also the current location of user 201, and the location of the next appointment on the calendar, virtual assistant may calculate a length of time for user 201 to travel between her current location and her destination, and also send the alarm to the proper location (e.g., when the user owns multiple devices capable of producing an alarm). By calculating this time (e.g., by using a driving directions service, such as Yahoo! Maps, Google Maps, or Mapquest), virtual assistant 101 can adjust an alarm. For example, if it will take user 201 one hour to get from her current location to her next appointment, virtual assistant can alert user 201 appropriately. Furthermore, if this is her first appointment of the day, virtual assistant 101 may adjust the alert time further to allow user 201 time to get ready.

If virtual assistant 101 not only knows the calendar and location of user 201, but also knows the current travel conditions, then virtual assistant 101 can further adjust the time of an alert. For example, virtual assistant 101 may retrieve the current weather condition from a website (e.g., an XML or RSS feed from the Weather Channel), and if conditions are poor (e.g., snowing, ice, rain, fog, etc.) then adjusting an alert time further. In other words, if weather is bad enough to affect traffic, then virtual assistant reschedules an alert earlier to account.

Virtual assistant 101 may further have information on mass transit delays or traffic delays from specialized websites. User 201 may previously have set up preferences, including preferred modes and routes of travel. With such information, virtual assistant 101 can further adjust an alert based on a slow down along the mode of transportation and route of user 201. Further, virtual assistant 201 may know the flight numbers and airlines of user 201, and subsequently be able to account for flight delays (e.g., as pulled from airline websites) when adjusting alerts.

Ultimately, once virtual assistant 101 has adjusted a time based on all the contextual information available, an alarm clock (or cell phone alarm, or computer alarm, etc.) can be adjusted based on the calculation. Virtual assistant 101 may be embedded as part of alarm clock 302, or the alarm clock may be remotely accessible by the virtual assistant. Alarm clock 302 may include a network adaptor, either wired or wireless, through which virtual assistant 201 can communicate. If alarm clock 302 is outfitted appropriately, possibly using audio interface 203, virtual assistant 101 may be able to provide a customized audio update for user 302. Such an update may include weather information, traffic information, upcoming appointments, and so forth. User 302 may be able to start, stop, or repeat such an update using a button or other interface on alarm clock 302. If an alarm is provided by a cell phone or computer, an audio update could likewise be provided via the various speakers attached to such devices. Because the virtual assistant 101 is aware of the user's location, the virtual assistant might only send an alarm to a single device, instead of repeating the alarm to multiple devices. That is, virtual assistant 101 may send an alarm to alarm clock 302, while precluding the alarm from going off on the user's computer, cell phone or PDA.

FIG. 4 is a flow chart illustrating a method for adjusting an alarm according to one or more aspects of the invention. The methods illustrated throughout this description are intended to provide possible implementations, and are not intended to be limiting. Individual steps may be combined, separated, deleted, or new steps may be added. Here, at step 401, an initial alarm time is determined by virtual assistant 101. This may be a default setting for all alarms. For example, all new appointments may have an alarm set 15 minutes before by default, or every morning, an alarm goes off at 6:00 am by default. Alternatively, the initial alarm time may be set by the user at the time of the creation of an appointment.

At step 402, context information is received by virtual assistant 101. This context information may include a geographic location of the user, as provided as an address or longitude and latitude coordinates. This information may be derived from a location of a cell phone or pager having geographic location sensing abilities (e.g., via global positioning GPS, or via cell tower location). Alternatively, a user may have entered this information into the calendar or preferences setting of virtual assistant 101. Additional context information may include accurate time and date information, weather information, traffic information, mass transit information, and so forth. Each piece information may be pulled or pushed from the same or separate network locations, possibly provided in XML or RSS format. The parsed information may be used later in the process.

At step 403, virtual assistant 101 adjusts the time of an appointment and/or an alarm on the basis of the user's time zone. If an appointment for a telephone call was set when user 201 was in her home time zone for 9:00 am eastern time, then if she goes on a trip to the central time zone, the appointment and its alarm will be moved to 8:00 am. In-person appointments, however, may not be adjusted. Virtual assistant 101 may be provided with default behavior to determine the difference between which appointments should be adjusted based on time zone. However, user 201 may set rules for rules engine 111 which modify the default behavior when adjusting for time zone.

At step 404, virtual assistant 101 may further adjust the time of an alarm based on appointments in a user's calendar. For example, if a default alarm is set to go off every morning at 6:00 am to wake a user, a 7:00 am appointment on the calendar may require that the user get up earlier. Virtual assistant 101 may know this based on a rule or default setting (e.g., “always wake user 1½ hours earlier than the earliest appointment”). Also, if a user's calendar contains information regarding a location for a next appointment, virtual assistant 101 may determine the travel time and adjust the alarm accordingly. For example, if a user has a sales call at a location which is a 45-minute drive from his current location according to Mapquest, then the initial 15 minute default may have 45 minutes added to it, producing an alarm one hour prior to the appointment. Also, if a user's calendar shows that the user is currently in another in-person appointment, the alarm on a cell phone or connected personal digital assistant (PDA) may be modified from a ring or buzzer to a vibration or SMS message in order to keep the alarm from disturbing others.

At decision 405, virtual assistant 101 decides whether or not travel is involved between a user's current location and her destination. To perform this determination, virtual assistant 101 knows the current location of user 201 as an address, GPS coordinate, etc. as well as the location of her next appointment. Virtual assistant 101 may then convert all locations to a common formation (e.g., street addresses) and use that format to determine travel distance using a service like Mapques® driving directions. If the user and her destination are close, then travel is likely not involved. Such a check may even be performed at the time of booking appointments in order to ensure that a user has adequate time to travel between adjacent appointments and also that the user has appropriate travel directions or instructions. Using GPS coordinates, virtual assistant may even determine the amount of time it takes to walk between closer destinations, and therefore adjust an alarm accordingly.

If travel is involved, then virtual assistant 101 at step 406 determines the mode of travel based on preferences and/or schedules, and determines any delay that may be caused by weather or traffic. The determination of time offset may be calculated based on live traffic information (e.g., “Interstate traffic delayed 10 minutes”) or default behaviors or user preferences (e.g., “if it is raining, add 15 minutes to my travel time”). Other calculations may be possible based on the quality of information provided by the external sources. Based on context information, virtual assistant 101 may even decide the mode of travel. For example, if the subway system is shut down, then virtual assistant 101 may send a message with an alert recommending that user 201 catch a cab.

Once a final alarm time is determined, then if the alarm location is remote, it is updated with the new time. At the appropriate time at step 407, the alarm is triggered.

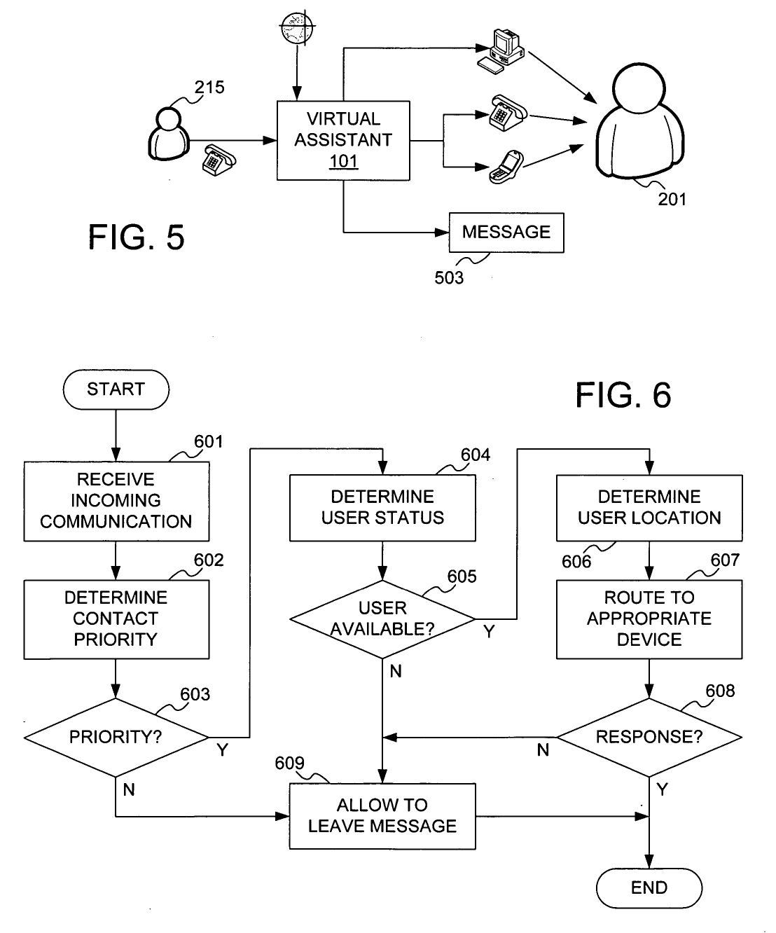

FIG. 5 depicts communication routing using virtual assistant 101 according to one or more aspects of the invention. If contact 215 attempts to telephone user 201, the call may be intercepted by virtual assistant 101. Virtual assistant 101 attempts to recognize contact 215 using caller ID (or some other system) and comparing the incoming number with the phone numbers of contacts in the user's database. If contact 215 is not recognized, then virtual assistant 101 may by default forward the contact to voicemail to leave a message 503. Alternatively, user 201 may set up rules to process the call differently, perhaps forwarding unrecognized callers to her secretary. If the contact 215 is recognized, then virtual assistant 101 may forward the call appropriately (according to predefined rules). Alternatively, user 201 may have previously set up address book categories and/or rules prioritizing incoming calls (e.g., all calls from Fred go to voicemail, or Sally and Susan are personal friends). If such is the case, then only recognized contacts from particular categories or meeting certain criteria may be forwarded to user 201, or even forwarded to voicemail.

Call routing as described here may be particularly well suited to the use of voice over internet protocol (VoIP). Such technology allows voice calls to be converted to and treated as data, making routing of calls a matter of forwarding VoIP packets to the appropriate terminating point (e.g., a cell phone, a computer, or a voice mail system).

In addition to recognizing incoming callers, virtual assistant 101 may further attempt to determine a location and status of user 201 before forwarding calls. As previously discussed, virtual assistant 101 may access the location of user 201 via a web service or through some other form of network connectivity. By knowing the location and the status of the contact, a call may be forwarded to user 201 or to voicemail. For example, if a contact marked as a personal friend of user 201 calls the user, then virtual assistant may determine that user 201 is located at home by recognizing his location and forward the call to a home or cell phone appropriately.

Determining a status of user 201 may involve determining the user's location (e.g., at a client's place of business) or determining any appointments presently on the user's calendar. User 201 may be able to prioritize and/or categorize the appointments on his calendar, and based on the current time and date, virtual assistant 101 may decide whether to forward a call based on the priority of the recognized contact and on the priority of the current appointment (e.g., sleeping is not to be interrupted, weekly status meeting may be interrupted by client calls). Alternatively, virtual assistant 101 may put contact 215 on hold and attempt to reach user 201 via phone or instant message. Virtual assistant may send the recognized contact information and let user 201 decide whether to take the call (e.g., “Fred Johnson is calling, would you like to take the call?”). Based on the answer of user 201, the call may then be forwarded to a voicemail system, or forwarded to the phone, cell phone, or even computer nearest to user 201.

FIG. 6 is a flow chart illustrating a method for routing an incoming communication according to one or more aspects of the invention. At step 601, an incoming message is received. At this point, a voice call may have already been converted to a digital call, perhaps in the form of VoIP packets. It should be noted that, to the extent that the address book of user 201 includes instant message contact information, the system described may be used for incoming electronic text messages as it can be with telephone calls. At step 602, the incoming communication is recognized as a contact in an effort to determine the sender's priority.

At decision 603, the priority of the incoming communication is determined based on its recognized sender. Priority rules may be as simple as all unrecognized calls go to voicemail. Or they may be a complex set of rules based on categories of contacts. For example, a rule could state that “all contacts from my company are high priority.” If a caller is not considered a high enough priority, then that user may be forwarded to voicemail at step 609, allowing the caller to leave a message. In the case of an electronic text message, a simple message alerting the sender to send an email may be sent in reply.

If a caller's priority is considered high enough to be forwarded, then at step 604, the user's current status is determined. Status may be determined based on the latest geographic location of user 201 based on information received by virtual assistant 101. For example, if user 201 is located at home or at a client's office, then the incoming call or message may automatically be sent to leave a message. Status may also be determined by examining the appointments on the calendar of user 201. If a calendar appointment shows that the user is in a high priority meeting, for example, then a caller may be forwarded to voicemail. Based on all this, and possibly other information (e.g., status entered manually by user, cell phone turned to vibrate or powered off, etc.), virtual assistant will determine at step 605 whether user 201 is currently available. If not, as stated, the incoming caller or message sender will be forwarded in order to leave message.

If the user is available, then based on the location at step 606, virtual assistant 101 may choose to which device the call or electronic communication should be forwarded, at step 607. If there is no response by user 201, then a call may still yet be forwarded to voicemail. Alternatively, virtual assistant 101 may attempt to send a text or email message to user 201 to determine the user's availability to take a particular call. If there is a response by user 201, then the process for virtual assistant 101 is effectively finished.

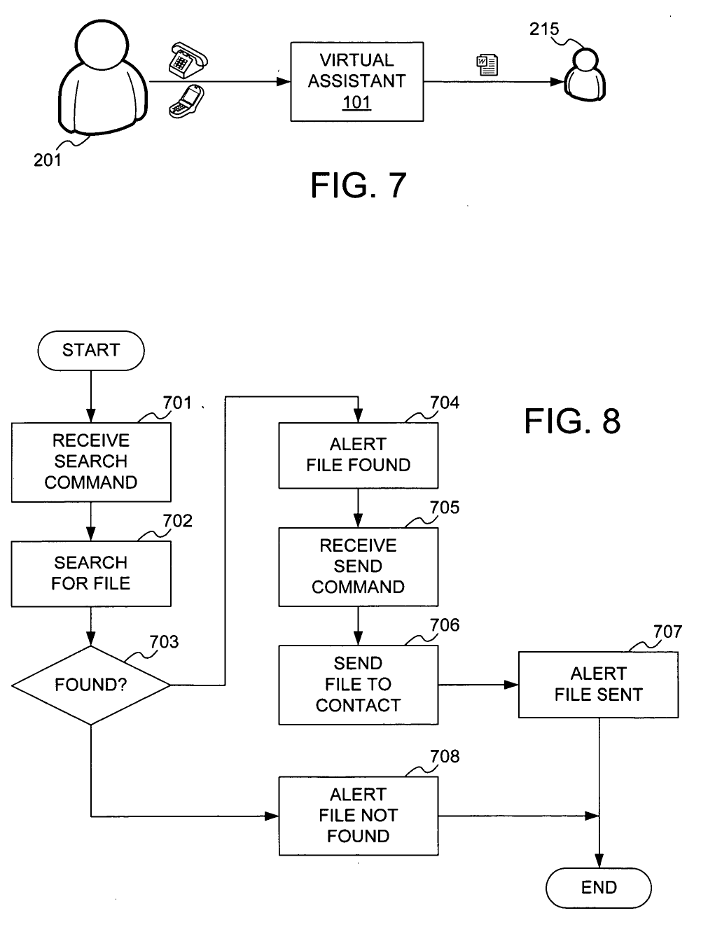

FIG. 7 depicts forwarding a file using virtual assistant 101 according to one or more aspects of the invention. Here, user 201 is controlling virtual assistant 101 using interactive voice response, simple messaging service (SMS) messages, or instant messages. A user can state commands orally or type them in for execution by virtual assistant 101. Below is one possible set of commands and responses making up a conversation between user 201 and virtual assistant 101:

User: “Find Document 2004 Taxes”—User 201 requests that virtual assistant 101 find a document “2004 Taxes.” The message may be spoken using IVR technology and converted to a text command which virtual assistant 101 can understand. The command may request a literal search for a document title “2004 Taxes” or it may search for the text string among all documents and find any matching the search string. The type of search may be set as a user preference. In order to perform a full text search, virtual assistant 101 may use its own query engine 114, or it may use an existing index of computer contents, such as one created by Google Desktop, or any other personal indexing software.

Virtual Assistant (VA): “Document 2004 Personal Taxes Found”—Virtual assistant 101 finds a document matching the search request and informs user 201. If multiple results had been found, then virtual assistant 101 might have informed the user of that fact, or it might have listed all of the found documents, letting the user select the correct one.

User: “Send Document by Fax to Contact Discovery Mortgage”—User 201 requests that the document be forwarded by facsimile to a contact in her address book. Alternative methods may include by Mail (e.g., the document is printed for paper delivery) or by Email (e.g., the document is attached to an email).

VA: “Document 2004 Personal Taxes Fax to Discovery Mortgage Queued”—The document has been placed in the queue to be faxed by virtual assistant 101. At this point, the conversation may end. If the conversation had occurred using instant messenger or SMS, then at a later point, virtual assistant 101 may send a final message alerting user 201 to the fact that the queued fax had been successfully delivered.

FIG. 8 is a flow chart illustrating a method for finding and forwarding a file according to one or more aspects of the invention. The method provided here represents steps possibly taken by virtual assistant 101 based on the conversation described above. At step 701, virtual assistant 101 receives and interprets a command from user 201. Interpreting the search command, virtual assistant 101 performs a document search based on the requested search string at step 702. At decision 703, if a file or other item is not found, then the user is alerted to that fact at step 709.

If a file is found, then user 201 is alerted via voice response or text message that the file is found at step 704. Then, virtual assistant 101 receives another command which is interpreted as a send command at step 705. At step 706, the send command is executed based on the parameters of the command. A contact may need to be sought in order to carry out the command. At step 707, the user is alerted to the fact that the document has been successfully sent or queued for sending.

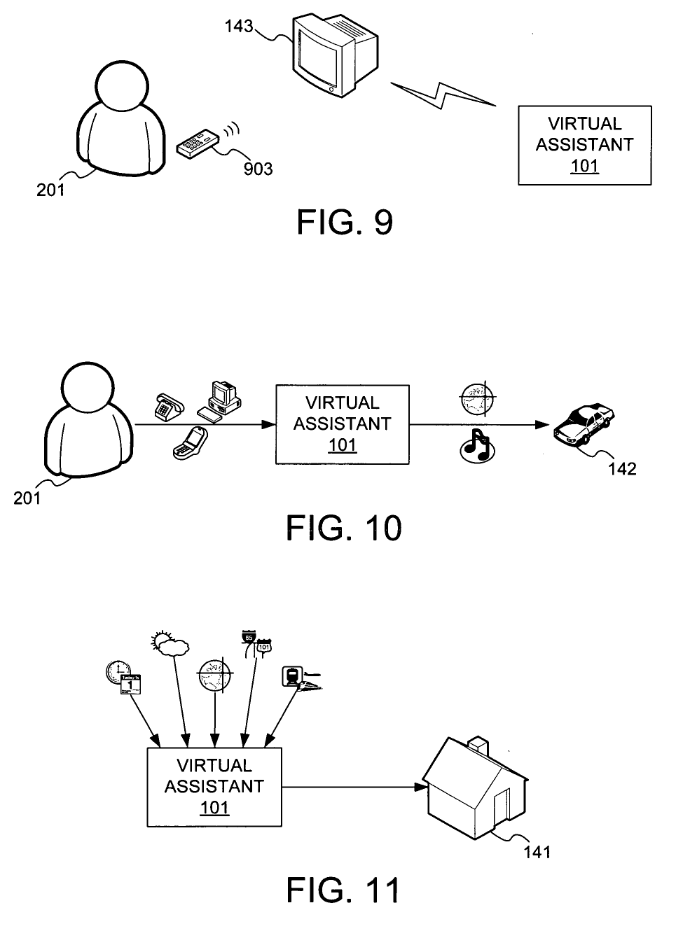

FIGS. 9-11 depict additional interfaces and uses for virtual assistant 101 according to various aspects of the invention. FIG. 9 depicts user 201 controlling virtual assistant 101 using a remote controlled television 143. Here, virtual assistant 101 provides an interface via a television. Through this interface, using remote control 903 as input, user 201 can control the functions of virtual assistant 101. This may include sending and receiving commands, similar to those described above. Virtual assistant 101 may further enable the checking of voicemail, the monitoring of a calendar, the viewing of email, and access to additional user data. Virtual assistant 101 may also enable the viewing of external data such as weather and traffic information using the television interface.

FIG. 10 depicts sending data to an automobile using virtual assistant 101 according to one or more aspects of the invention. Here, user 201 controls virtual assistant 101 using one of many interfaces. Similar to finding and sending a file to a contact described above, user 201 is able to find a contact or a data file (e.g., an MP3 music file) for use in automobile 142. Automobile 142 may be outfitted with a navigation system which also may control an audio system. By including a wireless network connection (e.g., WiFi, WiMAX, and/or Bluetooth), virtual assistant may be able to send files to automobile 142. Contacts may be sent in order to be used with an in-car navigation system, and music files may be sent for drive-time accompaniment. Other types of files may also be sent. In addition, virtual assistant 101 may provide an control interface accessible by an in-car navigation system so that a user can access and control her data, contacts, calendar, and so forth while on-the-go.

FIG. 11 depicts controlling functions within a house according to one or more aspects of the invention. Here, virtual assistant 101 may interact with home automation system 141 to interact with user 201 and/or control the functions of the home. For example, virtual assistant 201 may know when a user is headed for home, based on his calendar and/or his geographic location. Virtual assistant 101 may then turn on the lights and the air conditioning (which may have been turned down to save energy during the day). In addition, many home automation systems (e.g., Home Automation's Omni products) provide a console for graphical interfaces. Virtual assistant 101 may reside on a home computer and use a home automation console as its interface. Even if virtual assistant 101 is remotely located, an interface may be provided over a home broadband connection.

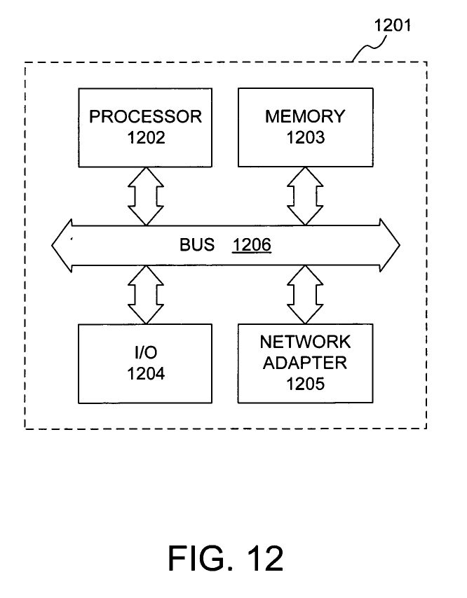

FIG. 12 is an illustrative operating environment in which one or more aspects of the invention may be implemented. The operating environment shown is minimal, and additional components may be included. This operating environment may be found within any of the devices described above, and use of virtual assistant 101 may only be limited by the speed and size of both the associated processor and memory. Device 1201 may be any sort of hardware minimally containing the components shown here, including at least one processor 1202, memory 1203, input/output 1204, network adapter 1205, and bus 1206 to link the components. This includes desktop computers, laptop computers, servers, cell phones, personal digital assistants (PDAs), home automation systems, digital televisions, automobile navigation systems, and so forth. Memory 1203 may include non-volatile memory such as a hard drive or flash memory, as well as volatile memory devices such as cache or various forms of dynamic random access memory (DRAM). Memory 1203 may store executable instructions which, when sent to processor 1202, causes computer 1201 to perform the steps required. Input/output 1204 may include interfaces for keyboard or mouse entry, or for other peripheral devices such as a scanner, a printer, a wireless connection (e.g., infrared or Bluetooth), and so forth. Optionally, functional components displayed within computer 1201 may be combined or separated into a single or multiple functional blocks. Bus 1206 may include more than one bus, linking different functional components through separate communication paths.

The present subject matter has been described in terms of preferred and exemplary embodiments thereof. It is to be understood that the subject matter defined in the appended claims is not necessarily limited to the specific features or acts described above. Rather, the specific features and acts described above are disclosed as example forms of implementing the claims.

We claim:

1. A system, comprising:
an information sources software module for receiving data from a plurality of information providers comprising a date/time provider, a weather information provider, a geographical location information provider, a travel route provider, a travel traffic provider, and a financial information provider;
a user interfaces software module for receiving input from and providing output to a plurality of heterogeneous user devices;
a user data module for storing data about a specific user, said data about the specific user comprising calendar appointment information, contact information, rules information, preferences information, file information, email information, and account information;
a functionality module for controlling operation of the system, said functionality module including:
a rules engine for analyzing and executing rules based on the rules information;
a real-time communication component, wherein an incoming communication directed to the user is routed by the real-time communication component, and wherein the routing is determined at least in part based on a recognized contact status as determined by comparison of a call identifier with the contact information, at least in part based on information received from one or more of the plurality of information providers via the information sources software module, at least in part based on a user availability status as determined by the functionality module comparing a current time and date with the calendar appointment information, and at least in part based on a geographic location of the user as determined by the geographic location information provider;
a speech processing module for analyzing speech input received from the user to control an action performed by the system;
a query/response module for querying information accessible by the system in response to user input.

2. A system, comprising:
an information sources software module for receiving data from a plurality of information providers;
a user interfaces software module for receiving input from and providing output to a plurality of heterogeneous user devices;
a user data module for storing data about a specific user, said data about the specific user comprising calendar appointment information, contact information, rules information, and preferences information;
a functionality module for controlling operation of the system, said functionality module including:
a rules engine for analyzing and executing rules based on the rules information,
a real-time communication component, wherein an incoming communication directed to the user is routed by the real-time communication component either to the user via the user interfaces software module or to a voice mail component, and wherein the routing is determined at least in part based on a recognized contact status as determined by comparison of a call identifier with the contact information, and at least in part based on information received from one or more of the plurality of information providers via the information sources software module.

3. The system of claim 2, wherein said data about the specific user further comprises file information, email information, account information, and the voice mail component.

4. The system of claim 2, wherein said functionality module further comprises a speech processing module for analyzing speech input received from the user.

5. The system of claim 2, wherein said functionality module further comprises a query/response module for querying information accessible by the system in response to user input.

6. The system of claim 2, wherein the plurality of information providers comprise a date/time provider, a weather information provider, a geographical location information provider, a travel route provider, a travel traffic provider, and a financial information provider.

7. The system of claim 2, wherein the plurality of heterogeneous user devices comprises a home computer, an automobile interface, and a mobile telephone.

8. The system of claim 7, wherein the plurality of heterogeneous user devices further comprises an alarm clock, and wherein the rules engine automatically alters an alarm time of the alarm clock based on information stored in the user data module.

9. The system of claim 8, wherein the rules engine further alters the alarm time of the alarm clock based on traffic information received from a travel traffic provider.

10. The system of claim 2, wherein the call routing is based further on a user availability status, as determined by the functionality module comparing a current time and date with the calendar appointment information.

11. The system of claim 6, wherein the call routing is based further on a geographic location of the user as determined by the geographic location information provider.

12. The system of claim 2, wherein the incoming communication comprises an audio communication.

13. The system of claim 2, wherein the incoming communication comprises a video communication.

14. The system of claim 2, wherein the incoming communication comprises a text communication.

15. The system of claim 2, wherein the incoming communication comprises an appointment reminder.

16. A system, comprising:
an information sources software module for receiving data from a plurality of information providers;
a user interfaces software module for receiving input from and providing output to a plurality of heterogeneous user devices;
a user data module for storing data about a specific user, said data about the specific user comprising calendar appointment information, contact information, rules information, and preferences information;
a functionality module for controlling operation of the system, said functionality module including:
a rules engine for analyzing and executing rules based on the rules information,
a real-time communication component, wherein an incoming communication directed to the user is routed by the real-time communication component, and wherein the routing is determined at least in part based on a recognized contact status as determined by comparison of a call identifier with the contact information, and at least in part based on information received from one or more of the plurality of information providers via the information sources software module.

17. The system of claim 16, wherein the call identifier indicates the caller is known the user.

18. The system of claim 16, wherein the call identifier indicates the caller is a personal information manager (PIM) application associated with the user.

19. The system of claim 16, wherein the incoming communication comprises an audio communication.

20. The system of claim 16, wherein the incoming communication comprises a video communication.

21. The system of claim 16, wherein the incoming communication comprises a text communication.

22. The system of claim 16, wherein the incoming communication comprises an appointment reminder.
